(19) United States
(12) Patent Application Publication
(10) Pub. No.: US 2023/0245812 A1
(43) Pub. Date: Aug. 3, 2023

(54) COIL DEVICE AND METHOD FOR MANUFACTURING THE SAME

(71) Applicant: TDK CORPORATION, Tokyo (JP)

(72) Inventors: Naoto TSUKAMOTO, Tokyo (JP); Sena YOSHINO, Tokyo (JP); Tomohiko AIDA, Tokyo (JP); Shigeki YANAGIDA, Tokyo (JP); Masashi GOTOH, Tokyo (JP); Hirofumi SASAKI, Tokyo (JP); Hitoshi SASAKI, Tokyo (JP)

(73) Assignee: TDK CORPORATION, Tokyo (JP)

(21) Appl. No.: 18/161,332

(22) Filed: Jan. 30, 2023

(30) Foreign Application Priority Data
Jan. 31, 2022 (JP) 2022-013251

(51) Int. Cl. H01F 27/255; H01F 41/02; H01F 27/28; H01F 27/30

(52) U.S. Cl. CPC H01F 27/255; H01F 41/0246; H01F 27/2823; H01F 27/306

(57) ABSTRACT

A coil device 1 comprises a coil 10, a T-shaped core 20 including a columnar portion 21 around which the coil 10 is disposed and a flange 22 formed at a first end 21a of the columnar portion 21 in an axial direction thereof, and an exterior body 30 covering the coil 10 and the columnar portion 21 and made of an exterior material including magnetic particles and a resin. The core 20 is provided with a recess 40 including at least one of a first recess 41 or a second recess 42. The first recess 41 extends between the first end 21a and a second end 21b of the columnar portion 21 in the axial direction. The second recess 42 extends from an inner side towards an outer side of the flange 22.

The present application claims a priority on the basis of Japanese patent application No. 2022-013251 filed on Jan. 31, 2022, which is incorporated herein by reference in its entirety.

### BACKGROUND

The present disclosure relates to a coil device in which an exterior body covers a coil and a method for manufacturing the same.

A coil device in which an exterior body covers a columnar portion and a coil as shown in, for example, Patent Document 1 is known as a coil device used as an inductor or the like. The exterior body can cover the columnar portion by various molding techniques, such as dry molding, injection molding, transfer molding, and compression molding. When these molding techniques are used, a core having the coil disposed around the columnar portion is placed in a cavity, and the cavity is filled with an exterior material including magnetic particles and a resin. Filling the cavity with the exterior material so that the coil is covered with the exterior material and then compressing and hardening the material can manufacture the coil device in which the exterior body covers the coil.
Patent Document 1: JP Patent Application Laid Open No. 2019-021781

### SUMMARY

A coil device according to one aspect of the present disclosure includes:

a coil;

a T-shaped core including a columnar portion around which the coil is disposed and a flange formed at a first end of the columnar portion in an axial direction thereof; and

an exterior body covering the coil and the columnar portion and made of an exterior material including magnetic particles and a resin; in which

the core is provided with a recess including at least one of a first recess or a second recess;

the first recess extends between the first end and a second end of the columnar portion in the axial direction; and

the second recess extends from an inner side towards an outer side of the flange.

A method of manufacturing a coil device according to one aspect of the present disclosure includes:

preparing a T-shaped core having a recess extending from a columnar portion of the core to a flange formed at a first end of the columnar portion in an axial direction thereof;

disposing a coil around the columnar portion;

disposing the core with the coil in a cavity so that the flange abuts a bottom of the cavity;

filling the cavity with an exterior material including magnetic particles and a resin so that part of the exterior material flows into the recess; and

compressing the exterior material.

### BRIEF DESCRIPTION OF THE DRAWING(S)

FIG. 1A is a perspective view of an example of a coil device according to a first aspect of the subject technology.

FIG. 1B is a perspective view of a modified example of the coil device shown in FIG. 1A.

FIG. 2A is a perspective view of an example of a core shown in FIG. 1A.

FIG. 2B is a cross-sectional view of an example of a columnar portion of the core shown in FIG. 2A.

FIG. 3A is a sectional view of the coil device along line IIIA-IIIA shown in FIG. 1A.

FIG. 3B is a sectional view of the coil device along line IIIB-IIIB shown in FIG. 1A.

FIG. 4A is a perspective view of an example of a core of a coil device according to a second aspect of the subject technology.

FIG. 4B is a cross-sectional view of an example of a columnar portion of the core shown in FIG. 4A.

FIG. 5A is a perspective view of an example of a core of a coil device according to a third aspect of the subject technology.

FIG. 5B is a cross-sectional view of an example of a columnar portion of the core shown in FIG. 5A.

FIG. 6A is a perspective view of an example of a core of a coil device according to a fourth aspect of the subject technology.

FIG. 6B is a cross-sectional view of an example of a columnar portion of the core shown in FIG. 6A.

FIG. 7A is a perspective view of an example of a core of a coil device according to a fifth aspect of the subject technology.

FIG. 7B is a cross-sectional view of an example of a columnar portion of the core shown in FIG. 7A.

FIG. 8 is a perspective view of an example of a core of a coil device according to a sixth aspect of the subject technology.

FIG. 9 is a perspective view of an example of a core of a coil device according to a seventh aspect of the subject technology.

FIG. 10 is a perspective view of an example of a core of a coil device according to an eighth aspect of the subject technology.

FIG. 11 is a perspective view of an example of a core of a coil device according to a ninth aspect of the subject technology.

FIG. 12 is a perspective view of a modified example of a core from which second recesses shown in FIG. 2A are omitted.

FIG. 13 is a perspective view of a modified example of a core from which first recesses shown in FIG. 2A are omitted.

### DETAILED DESCRIPTION

Hereinafter, the present disclosure will be explained based on embodiments shown in the drawings.

### First Embodiment

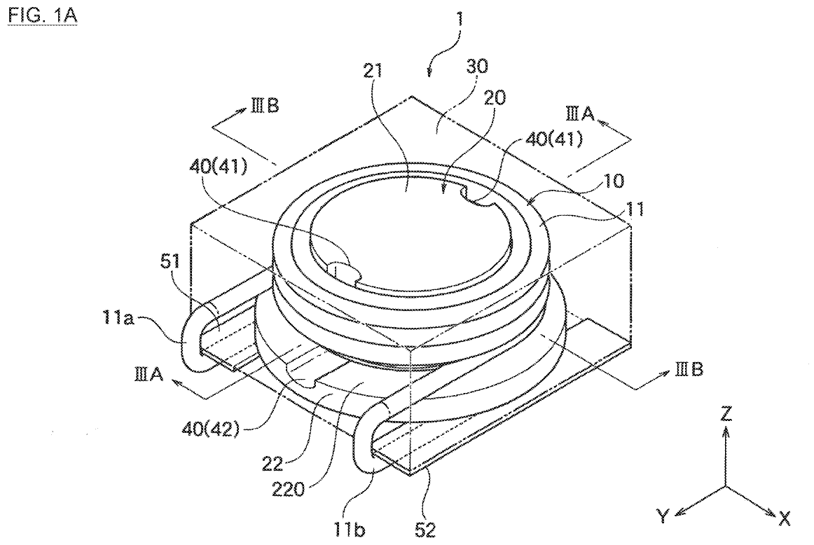

A coil device 1 of a first embodiment shown in FIG. 1 functions as, for example, an inductor and is used in, for example, a DC/DC converter in a power supply circuit and a filter circuit. The coil device 1 may have any size. For example, the dimension of the coil device 1 in an X-axis direction is 0.6 to 6.5 mm; the dimension thereof in a Y-axis direction is 0.6 to 6.5 mm; and the dimension thereof in a Z-axis direction is 0.5 to 5.0 mm. In the following description, a positive direction of the Z-axis is an upward direction, and a negative direction of the Z-axis is a downward direction; a positive direction of the Y-axis is a forward direction (front), and a negative direction of the Y-axis is a backward direction (rear); and a direction towards a center of the coil device 1 is an inward direction, and a direction away from the center of the coil device 1 is an outward direction.

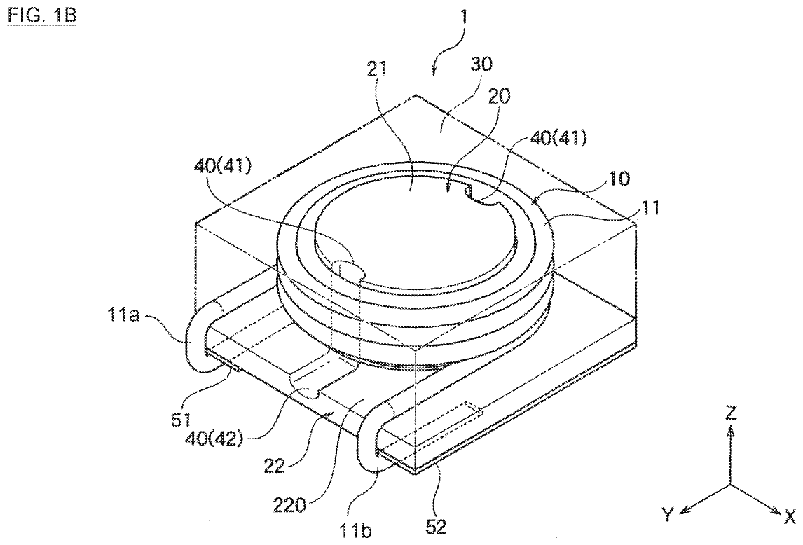

The coil device 1 includes a coil 10, a core 20, and an exterior body 30. As shown in FIG. 2A, the core 20 is substantially T-shaped and is made of a resin including magnetic particles (a magnetic powder). The core 20 is formed by, for example, compaction molding, injection molding, or machining.

Examples of the magnetic particles (magnetic material) forming the core 20 include ferrite particles and metal magnetic particles. Examples of the ferrite particles include Ni—Zn based ferrite and Mn—Zn based ferrite. The metal magnetic particles are not limited. Examples of the metal magnetic particles include an Fe—Ni alloy powder, an Fe—Si alloy powder, an Fe—Si—Cr alloy powder, an Fe—Co alloy powder, an Fe—Si—Al alloy powder, and amorphous iron. The resin forming the core 20 is not limited. Examples of the resin include an epoxy resin, a phenol resin, a polyester resin, a polyurethane resin, a polyimide resin, other synthetic resins, and other non-magnetic materials.

The core 20 includes a columnar portion 21 and a flange 22. The columnar portion 21 has a substantially cylindrical shape and is formed on an upper surface 220 of the flange 22. An axial direction of the columnar portion 21 corresponds to the Z-axis direction. Around the columnar portion 21, the coil 10 shown in FIG. 1A may be disposed. In some embodiments, the shape of the columnar portion 21 is not limited to the cylindrical shape and may be a polygonal prism (e.g., a quadrangular prism and a hexagonal prism).

The flange 22 is formed at a first end 21a of the columnar portion 21 in its axial direction (the Z-axis direction). In the present embodiment, unlike a drum core, the flange 22 is formed only at the first end 21a of the columnar portion 21, and no flange is formed at a second end 21b of the columnar portion 21. The flange 22 has a disc shape having a predetermined thickness in the Z-axis direction. Although the flange 22 has a circular shape when viewed from below, the flange 22 may have a polygonal shape (e.g., a rectangular shape) as shown in FIG. 1B.

As shown in FIG. 2A, two recesses 40 are formed on a surface of the core 20 so that the recesses 40 extend from the columnar portion 21 to the flange 22. Details of the recesses 40 will be explained later.

As shown in FIG. 1A, the coil 10 is made of a wire 11 wound in a coil shape. The wire 11 is a round wire and is composed of, for example, a copper wire covered with an insulating coating. The wire 11 has a diameter of, for example, 100 to 250 μm. The coil 10 is formed by winding the wire 11 around an outer peripheral surface 210 of the columnar portion 21. However, the coil 10 may be an air core coil, and the air core coil may be disposed around the columnar portion 21.

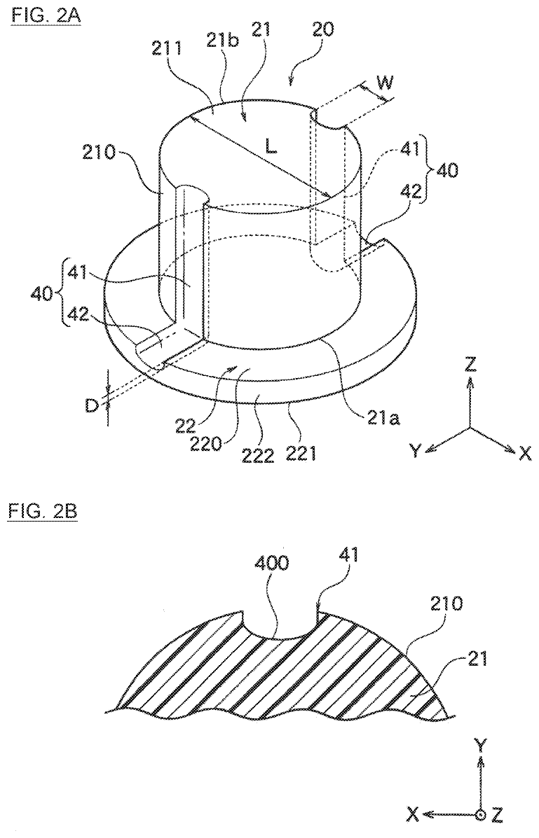

The wire 11 is not limited to a round wire and may be, for example, a rectangular wire, a square wire, or a litz wire. For example, the coil 10 may be an air core coil including a crosswise wound rectangular wire or an edgewise wound rectangular wire. Although the number of layers of the coil 10 in its radial direction is two as shown in FIG. 3A, the number may be any number that is one or more.

As shown in FIG. 1A, the exterior body 30 is made of an exterior material including magnetic particles and a resin and covers the coil 10 and the columnar portion 21. The exterior material may include, for example, a filler. The exterior body 30 has a substantially rectangular parallelepiped shape and is joined to the surface of the core 20. The exterior body 30 is formed by, for example, pouring the exterior material into a cavity of a mold where the core 20 is placed and compressing and hardening the material.

Although part of the exterior body 30 is positioned at surroundings of the flange 22 (e.g., lateral sides of the flange 22), the exterior body 30 may be formed so that the exterior body 30 as a whole is substantially disposed above the upper surface 220 of the flange 22 as shown in FIG. 1B. The core 20 shown in FIG. 1B has a plate shape having a predetermined thickness in the Z-axis direction, and the flange 22 has a rectangular shape when viewed from below.

Although the magnetic particles (magnetic material) forming the exterior body 30 are the same as the above-mentioned magnetic particles (magnetic material) forming the core 20, these magnetic particles (magnetic materials) may be different types. The magnetic particles forming the exterior body 30 may have a size of 1 to 50 μm or 1 to 20 μm. Although the resin forming the exterior body 30 is the same as the above-mentioned resin forming the core 20, these resins may be different types.

The exterior body 30 and the core 20 may have different relative permeability. For example, the exterior body 30 may be composed of a material having smaller relative permeability than the core 20. The relative permeability of the exterior body 30 is not limited and is, for example, 1 to 20,000. The same applies to the core 20.

The core 20 (the columnar portion 21 and/or the flange 22) and the exterior body 30 may have different thermal expansion coefficients. For example, the thermal expansion coefficient of the core 20 (the columnar portion 21 and/or the flange 22) may be smaller than that of the exterior body 30.

For example, the thermal expansion coefficient of the columnar portion 21 is 10 ppm/K, and the thermal expansion coefficient of the exterior body 30 is 15 ppm/K. The difference between the thermal expansion coefficients of the columnar portion 21 and the exterior body 30 may be 2 ppm or more or may be 5 ppm or more. This structure allows for prevention of cracks of the exterior body 30 covering the columnar portion 21 due to the thermal expansion coefficient of the columnar portion 21.

Examples of methods of making the thermal expansion coefficient of the columnar portion 21 smaller than that of the exterior body 30 include heating of the columnar portion 21. When the columnar portion 21 includes the magnetic particles and the resin, heating the columnar portion 21 can reduce the content ratio of the resin to reduce the thermal expansion coefficient of the columnar portion 21.

In some embodiments, the core 20 may be made of a material (magnetic particles) different from the exterior body 30 to make the thermal expansion coefficient of the columnar portion 21 smaller than that of the exterior body 30. Alternatively, when the core 20 and the exterior body 30 both include the magnetic particles and the resin, a mixing ratio of the resin in the core 20 may be smaller than a mixing ratio of the resin in the exterior body 30 to make the thermal expansion coefficient of the columnar portion 21 smaller than that of the exterior body 30.

As shown in FIG. 1A, the coil device 1 further includes a first electrode 51 and a second electrode 52. The first electrode 51 and the second electrode 52 are formed on a lower surface of the exterior body 30 or a lower surface of the flange 22. In the coil device 1 shown in FIG. 1B, the first electrode 51 and the second electrode 52 are formed on the lower surface of the flange 22.

As shown in FIG. 1A, the first electrode 51 is disposed at one side in the X-axis direction, and the second electrode 52 is disposed at the other side in the X-axis direction. A first lead-out portion 11a of the wire 11 is connected to the first electrode 51, and a second lead-out portion 11b of the wire 11 is connected to the second electrode 52. The first lead-out portion 11a and the second lead-out portion 11b are connected to the first electrode 51 and the second electrode 52 respectively using, for example, thermocompression bonding, solder, or a conductive adhesive.

The first electrode 51 and the second electrode 52 are each composed of, for example, a multilayer electrode film including a base electrode film and a plating film formed thereon. Examples of the base electrode film include a conductive paste film containing metal (e.g., Sn, Ag, Ni, and Cu) and their alloy. Examples of the plating film include metal (e.g., Sn, Au, Ni, Pt, Ag, and Pd) and their alloy. The first electrode 51 and the second electrode 52 each have a thickness of, for example, 3 to 100 μm.

As shown in FIG. 3A, the first lead-out portion 11a is drawn out forwards from the inside of the exterior body 30 to a side (front) of the exterior body 30 and then downwards along the side of the exterior body 30. The first lead-out portion 11a is further drawn out backwards along the lower surface of the exterior body 30 or the lower surface of the flange 22. The same applies to the second lead-out portion 11b (see FIG. 1A).

In some embodiments, the shapes of the first electrode 51 and the second electrode 52 are not limited to the shape (sheet shape) shown in the drawings and may be changed as appropriate. For example, part of the first electrode 51 may be formed on the side (front) of the exterior body 30, and the first lead-out portion 11a and the first electrode 51 may be connected at the front of the exterior body 30. Similarly, part of the second electrode 52 may be formed on the side (front) of the exterior body 30, and the second lead-out portion 11b and the second electrode 52 may be connected at the front of the exterior body 30.

As shown in FIGS. 3A and 3B, for example, in a process of manufacturing the coil device 1, a small space G1 may be formed between the outer peripheral surface 210 of the columnar portion 21 and an inner peripheral surface 10b of the coil 10 when the coil 10 is disposed around the columnar portion 21. Similarly, a small space G2 may be formed between the upper surface 220 of the flange 22 and a bottom surface 10a of the coil 10. The space G1 is a space surrounded by an outer peripheral surface of the wire 11 and the outer peripheral surface 210 of the columnar portion 21 and may have a width smaller than the size of the above-mentioned magnetic particles on average. The space G2 is a space surrounded by the outer peripheral surface of the wire 11 and the upper surface 220 of the flange 22 and may have a width smaller than the size of the above-mentioned magnetic particles on average.

As explained above, the exterior body 30 is formed by, for example, pouring the exterior material into the cavity of the mold where the core 20 is placed and compressing and hardening the material. Because it is difficult for the exterior material (particularly the magnetic particles) to enter the spaces G1 and G2 from an outer side of the coil 10 when the coil 10 is disposed around the columnar portion 21, an air gap may be formed in the spaces G1 and G2 unless a measure is taken.

Because the air gap has lower permeability than the exterior material does, formation of the air gap is a factor in relative reduction of magnetic properties of the coil device 1. Thus, in terms of improving the magnetic properties, it is desirable that formation of the air gap in the spaces G1 and G2 should be prevented. The air gap also reduces adhesion between the coil 10 and the columnar portion 21 to become a factor in misalignment of the coil 10 with respect to the columnar portion 21 or reduction of yield of the coil device 1 due to the misalignment. Thus, also in terms of improving the yield of the coil device 1, it is desirable that formation of the air gap in the spaces G1 and G2 should be prevented. Therefore, in the present embodiment, the two recesses 40 are formed on the surface of the core 20 as shown in FIG. 2A to prevent formation of the air gap in the spaces G1 and G2. Hereinafter, the recesses 40 will be explained.

Each of the two recesses 40 extends in a substantially L shape and is formed from the columnar portion 21 to the flange 22. One recess 40 and the other recess 40 may have 180-degree rotational symmetry with respect to the axis of the columnar portion 21 or the winding axis of the coil 10 (FIG. 1A). Each recess 40 includes a first recess 41 and a second recess 42.

The first recess 41 is formed on the outer peripheral surface 210 of the columnar portion 21 and extends from the second end 21b to the first end 21a of the columnar portion 21 along the axial direction of columnar portion 21 and the winding axis direction of the coil 10 (FIG. 1A). The first recess 41 extends continuously and linearly from the second end 21b to the first end 21a (where the upper surface 220 of the flange 22 and the outer peripheral surface 210 of the columnar portion 21 meet) of the columnar portion 21. Thus, the first recess 41 and the columnar portion 21 have the same length along the Z-axis direction. At the second end 21b of the columnar portion 21, the periphery of an upper surface 211 of the columnar portion 21 is partly cut off by the first recess 41.

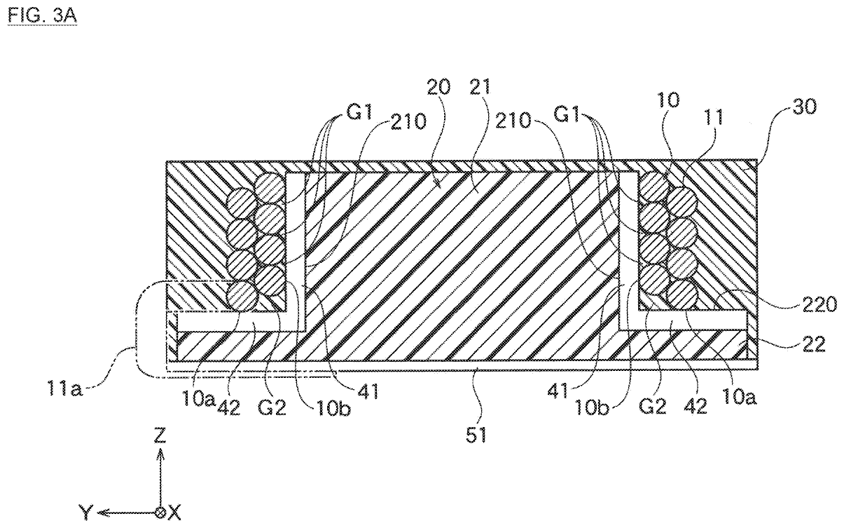

As shown in FIG. 2B, the first recess 41 has a substantially semicircular cross-sectional shape (sectional shape cut in parallel to the XY plane), and an inner wall 400 of the first recess 41 is smoothly curved. However, the first recess 41 may have any other cross-sectional shape, and the shape may be changed as appropriate as explained later (see, for example, FIG. 4B).

As shown in FIG. 2A, the second recess 42 is formed on the upper surface 220 of the flange 22 and extends from an inner side towards an outer side of the flange 22 along the radial direction of the flange 22 (or the direction parallel to the radial direction of the columnar portion 21). The second recess 42 is interconnected with the first recess 41 at the first end 21a of the columnar portion 21. The second recess 42 extends continuously and linearly from where the upper surface 220 of the flange 22 and the outer peripheral surface 210 of the columnar portion 21 meet to an outer edge of the flange 22 in its radial direction. Although an inner wall of the second recess 42 has the same shape as the inner wall of the first recess 41, the shapes may be different. Although the second recess 42 extends parallel to the radial direction of the flange 22, the second recess 42 may extend in a direction inclined to the radial direction of the flange 22.

At the second end 21b of the columnar portion 21, upper ends of the respective recesses 40 (first recesses 41) in the Z-axis direction are open ends. At a side surface 222 of the flange 22, outer ends of the respective recesses 40 (second recesses 42) in the radial direction are open ends. Because the flange 22 is not formed at the second end 21b of the columnar portion 21 of the coil device 1 of the present embodiment, neither end of the recesses 40 is blocked. The recesses 40 thus function as a passage where the exterior material forming the exterior body 30 flows when the exterior body 30 is molded as explained above. Thus, the exterior material can be guided into the recesses 40 from the upper ends of the first recesses 41 in the Z-axis direction.

For example, at the time of molding the exterior body 30, by placing the core 20 in the cavity in the same direction as the core 20 shown in the drawings (i.e., so that a lower surface 221 of the flange 22 abuts the bottom of the cavity) and filling the cavity with the exterior material having fluidity, part of the exterior material flows into the first recesses 41 through the upper ends of the first recesses 41 in the Z-axis direction. The exterior material that has flowed into the first recesses 41 flows into the second recesses 42 and then out of the second recesses 42 through the outer ends of the second recesses 42 in the radial direction.

In a process in which the exterior material flows inside the first recesses 41 and the second recesses 42, part of the exterior material that has flowed into the first recesses 41 overflows the first recesses 41 (particularly, outwards in the radial direction of the columnar portion) and enters the space G1 (particularly, the space G1 in the vicinity of the first recesses 41) shown in FIG. 3A. Similarly, part of the exterior material that has flowed into the second recesses 42 flows outside the second recesses 42 (particularly, outside in the circumferential direction) and enters the space G2 (particularly, the space G2 in the vicinity of the second recesses 42) shown in FIG. 3A. The exterior material with which the first recesses 41 and the second recesses 42 are filled is omitted in FIG. 3A to prevent complexity of the drawing.

As a result, as shown in FIG. 3A, the spaces G1 and G2 are filled with both the magnetic particles and the resin included in the exterior material. In the spaces G1 and G2, the inner peripheral surface 10b of the coil 10 and the outer peripheral surface 210 of the columnar portion 21 are connected by the exterior material, and the bottom surface 10a of the coil 10 and the upper surface 220 of the flange 22 are connected by the exterior material. Also, in the spaces G1 and G2, turns of the wire 11 are connected by the exterior material. In the present embodiment, formation of the air gap in the spaces G1 and G2 can be prevented in this way. This enables the volume of the exterior body 30 to be increased by the amount of the exterior material that has flowed into the spaces G1 and G2, allowing for improvement of the magnetic properties of the coil device 1. Filling the spaces G1 and G2 with the exterior material can also reduce cracks and bursts starting at the air gap.

In the present embodiment, the spaces G1 and G2 can be filled with the exterior material not only from the outer side of the coil 10 but also from an inner side of the coil 10 (between the inner peripheral surface 10b of the coil 10 and the outer peripheral surface 210 of the columnar portion 21, or between the bottom surface 10a of the coil 10 and the upper surface 220 of the flange 22). When the coil 10 is an air core coil, a clearance may be inevitably formed between the outer peripheral surface 210 of the columnar portion 21 and the inner peripheral surface 10b of the coil 10 in manufacturing, which may reduce adhesion between the outer peripheral surface 210 of the columnar portion 21 and the inner peripheral surface 10b of the coil 10. In the present embodiment, the exterior material can also flow into such a clearance through the first recesses 41 from the inner side of the coil 10.

Once the cavity is filled with a certain amount or more of the exterior material, the exterior material that has flowed into the recesses 40 does not readily flow any more. Thus, the recesses 40 are filled with the exterior material, and the exterior material hardens inside the recesses 40. Consequently, at the first recesses 41, the outer peripheral surface 210 of the columnar portion 21 and the inner peripheral surface 10b of the coil 10 are joined by the exterior material inside the first recesses 41. Similarly, at the second recesses 42, the upper surface 220 of the flange 22 and the bottom surface 10a of the coil 10 are joined by the exterior material inside the second recesses 42.

As shown in FIG. 2A, a width W of the recesses 40 (each including both the corresponding first recess 41 and the corresponding second recess 42) in a direction orthogonal to the extending direction of the recesses 40 is substantially constant at any location along the extending direction of the recesses 40. The width W of the recesses 40 is preferably larger than the size of the magnetic particles included in the exterior material. The width W of the recesses 40 is, for example, 50 μm or more. In this case, the magnetic particles included in the exterior material can smoothly flow into the spaces G1 and G2 through the recesses 40.

A ratio W/L may be 1/32 to ¼ or 1/8 to 1/4, where W is the width of the recesses 40 in the direction orthogonal to the extending direction and L is the length (diameter) of the columnar portion 21 in its radial direction. In this case, a sufficient amount of the exterior material can flow into the recesses 40, and a sufficient amount of the exterior material can flow into the spaces G1 and G2 through the recesses 40.

The spaces G1 and G2 shown in FIGS. 3A and 3B tend to become larger in proportion to the diameter of the wire 11 of the coil 10. Thus, in terms of enabling a smooth flow of the exterior material into the spaces G1 and G2, the width W of the recess 40 is preferably a size determined in proportion to the diameter of the wire 11. For example, the width W of the recess 40 may be the same as or larger than the diameter of the wire 11.

The recesses 40 have a depth D, shown in FIG. 2A, which is substantially constant at any location along the extending direction of the recesses 40. The depth D of the recesses 40 is preferably larger than the size of the magnetic particles included in the exterior material. The depth D of the recesses 40 is, for example, 50 μm or more. In this case, a sufficient amount of the exterior material can flow into the recesses 40, and the magnetic particles included in the exterior material can smoothly flow into the spaces G1 and G2 through the recesses 40.

The coil device 1 is manufactured, for example, using the following method. First, the core 20 shown in FIG. 2A is prepared, and the coil 10 shown in FIG. 1A is disposed around the columnar portion 21. For example, the coil 10 may be formed by directly winding the wire 11 around the columnar portion 21 or may be an air core coil.

Next, the core 20 is placed in the cavity of the mold, and the cavity is filled with the exterior material. At this time, the core 20 is disposed in the cavity of the mold so that the lower surface 221 (FIG. 2A) of the flange 22 abuts the bottom of the cavity. As the exterior material, a material having fluidity is used. As the exterior material, a complex magnetic material including a thermoplastic resin or a thermosetting resin as a binder is used. Next, the exterior material inside the cavity is compressed and hardened to give the exterior body 30. Molding of the exterior body 30 as described above may be performed by various molding techniques, such as compression molding and transfer molding. These molding techniques allow the exterior material to flow into the spaces G1 and G2 through the recesses 40 shown in FIG. 3A from the inner side of the coil 10 or the bottom side of the coil 10.

Next, as shown in FIG. 1A or FIG. 1B, the first electrode 51 and the second electrode 52 are formed on the lower surface of the exterior body 30 or the lower surface of the flange 22. The first electrode 51 and the second electrode 52 may be formed by various techniques, such as a paste method, a plating method, sputtering, and screen printing. Next, the first lead-out portion 11a is connected to the first electrode 51, and the second lead-out portion 11b is connected to the second electrode 52. The above process may give the coil device 1.

In some embodiments, a plurality of sections (rooms) may be formed in the cavity used in the above-mentioned method of manufacturing the coil device 1, and a plurality of cores 20 may be placed in the respective sections. In this case, the sections may be filled with the exterior material separately, and the exterior material in each section may be compressed and hardened separately, so that the exterior material does not connect the cores 20 when the cavity is filled with the exterior material. This can give a plurality of molded bodies, i.e. the cores 20 each covered with the exterior body 30.

Alternatively, the cavity may be entirely filled with the exterior material, and the exterior material may be compressed and hardened, so that the exterior material connects the cores 20. This can give one molded body, i.e. the cores 20 collectively covered with the exterior body 30. In this case, cutting the molded body with a dicer to singulate it into elements can give molded bodies, i.e. the cores 20 each covered with the exterior body 30.

As explained above, the coil device 1 of the present embodiment includes the substantially T-shaped core 20 having the flange 22 at the first end 21a of the columnar portion 21 in its axial direction as shown in FIG. 2A. Thus, when compression molding is particularly used to cover the columnar portion 21 and the coil 10 with the exterior body 30 among various molding techniques (e.g., injection molding, transfer molding, and compression molding), the following effects can be exhibited. Because the flange 22 is not formed at the second end 21b of the columnar portion 21 in its axial direction as shown in FIG. 2A in the coil device 1 of the present embodiment, the exterior material can flow in a surrounding area of the coil 10 (FIG. 1A) without being obstructed by the flange 22 when the cavity where the core 20 is placed is filled with the exterior material. Additionally, when the exterior material in the cavity is compressed, pressure applied to the cavity can be transmitted to the exterior material without being obstructed by the flange 22. Thus, the exterior body 30 can be formed at high quality (high density) more easily compared to when a so-called drum core is used. Moreover, when the coil 10 is an air core coil, the coil 10 can be easily fitted from the second end 21b of the columnar portion 21.

When transfer molding is used to cover the columnar portion 21 and the coil 10 with the exterior body 30, provided that the core 20 is substantially T-shaped (provided that the flange 22 is formed only at one side of the columnar portion 21 in its axial direction), the exterior material inside the cavity can have improved fluidity and smoothly flow in the surrounding area of the coil 10.

In the present embodiment, the volume of the exterior body 30 can be increased by the amount of the exterior material that has flowed into the spaces G1 and G2 shown in FIG. 3A, which allows for improvement of the magnetic properties of the coil device 1. In particular, the magnetic particles can enter the spaces G1 and G2 through the recesses 40. This significantly contributes to improvement of the magnetic properties (particularly the characteristics of saturation current) of the coil device 1. Further, filling the spaces G1 and G2 with the exterior material improves adhesion between the coil 10 and the columnar portion 21 and/or adhesion between the coil 10 and the flange 22, allowing prevention of misalignment of the coil 10 with respect to the columnar portion 21 and improvement of yield of the coil device 1.

In particular, when an air core coil is disposed around the columnar portion 21 in the process of manufacturing the coil device 1, the space G1 is readily formed between the outer peripheral surface 210 of the columnar portion 21 and the inner peripheral surface 10b of the coil 10. Even under such conditions in which the space G1 is readily formed, in the coil device 1 of the present disclosure, filling the recesses 40 (the first recesses 41) with part of the exterior material allows the space G1 to be filled and various defects caused by formation of the air gap in the space G1 to be prevented.

Moreover, because the inner wall 400 of each recess 40 is curved as shown in FIG. 2B, fluidity of the exterior material that flows inside the recess 40 is readily ensured, and the exterior material (particularly the magnetic particles) can be efficiently transferred through the recess 40 into the spaces G1 and G2.

The second recesses 42 are interconnected with the respective first recesses 41 at the first end 21a of the columnar portion 21. Thus, part of the exterior material that has flowed into the first recesses 41 flows into the second recesses 42, and part of the exterior material that has flowed into the second recesses 42 flows into the space G2 between the upper surface 220 of the flange 22 and the bottom surface 10a of the coil 10. This enables a sufficient amount of the exterior material to flow into the second recesses 42, allowing the space G2 between the upper surface 220 of the flange 22 and the bottom surface 10a of the coil 10 to be effectively filled with the exterior material to effectively prevent formation of the air gap in the space G2.

In using the method of manufacturing the coil device 1 of the present disclosure, part of the exterior material flows into the recesses 40 when the exterior material is poured into the cavity. Thus, the space G1 between the outer peripheral surface 210 of the columnar portion 21 and the inner peripheral surface 10b of the coil 10 and the space G2 between the upper surface 220 of the flange 22 and the bottom surface 10a of the coil 10 can be filled with the exterior material to prevent formation of the air gap in the spaces G1 and G2 and improve adhesion between the coil 10 and the columnar portion 21. This can improve the magnetic properties and yield of the coil device 1. Also, because the core 20 is substantially T-shaped, not only is it easy to form the exterior body 30 covering the coil 10, but also part of the exterior material can easily flow into the recesses 40 without being obstructed by the flange 22 when the cavity is filled with the exterior material.

### Second Embodiment

A coil device 1A of a second embodiment shown in FIG. 4A is identical to the coil device 1 of the first embodiment except for the following. In FIG. 4A, members other than a core 20A are omitted. In FIG. 4A, members common to the coil device 1 of the first embodiment are given the same reference numerals as in the first embodiment, and their detailed description is omitted.

As shown in FIG. 4A, the coil device 1A includes the core 20A. The core 20A is different from the core 20 of the first embodiment in that the core 20A includes recesses 40A. As shown in FIG. 4B, an inner wall 400A of a first recess 41A (the same applies to a second recess 42A) includes a bottom portion 410 and two side wall portions 420 at both sides of the bottom portion 410. Each of the side wall portions 420 extends so as to stand in a direction orthogonal to the bottom portion 410, and the inner wall 400A is not curved as shown in FIG. 2B.

The present embodiment can also achieve the same effects as in the first embodiment. Additionally, in the present embodiment, the shape of the inner wall 400A allows for a larger volume of the recesses 40A than the recesses 40 of the first embodiment. Thus, the amount of the exterior material that flows in the recesses 40A can be increased to let the exterior material efficiently flow into the spaces G1 and G2 (FIG. 3A) through the recesses 40A.

### Third Embodiment

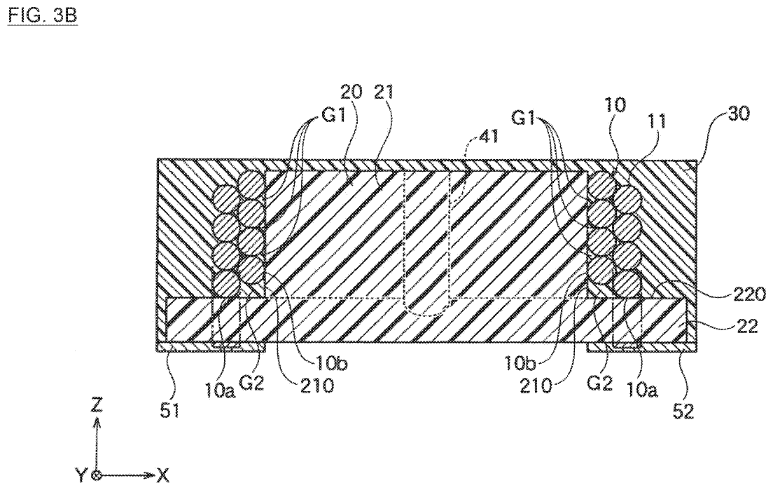

A coil device 1B of a third embodiment shown in FIG. 5A is identical to the coil device 1A of the second embodiment except for the following. In FIG. 5A, members other than a core 20B are omitted. In FIG. 5A, members common to the coil device 1A of the second embodiment are given the same reference numerals as in the second embodiment, and their detailed description is omitted.

As shown in FIG. 5A, the coil device 1B includes the core 20B. The core 20B is different from the core 20A of the second embodiment in that the core 20B includes recesses 40B. As shown in FIG. 5B, side wall portions 420 of an inner wall 400B of a first recess 41B (the same applies to a second recess 42B) include angled portions (angled surfaces). Thus, as shown in FIG. 5A, each recess 40B has a width W that narrows towards the bottom of the recess 40B.

The present embodiment can also achieve the same effects as in the second embodiment. Additionally, in the present embodiment, because the inner wall 400B includes the angled portions, the surface area of the inner wall 400B can be larger than that of the recesses 40A of the second embodiment. Thus, bonding strength between the exterior material with which the recesses 40B are filled and the inner wall 400B can be increased, which can prevent peeling defects of the exterior body 30 (FIG. 1A).

Moreover, because the inner wall 400B includes the angled portions having the shape shown in FIG. 5B, part of the exterior material that has flowed into the recesses 40B readily outflows outside (into a surrounding area of) the recesses 40B. That is, the exterior material that has entered the recesses 40B easily gets over the side wall portions 420 of the inner wall 400B and flows into the spaces G1 and G2 (FIG. 3A) in the surrounding area of the recesses 40B. Thus, the spaces G1 and G2 in the surrounding area of the recesses 40B can be efficiently filled with the exterior material. This effectively prevents formation of the air gap in the spaces G1 and G2 to effectively improve the magnetic properties and yield of the coil device 1B.

### Fourth Embodiment

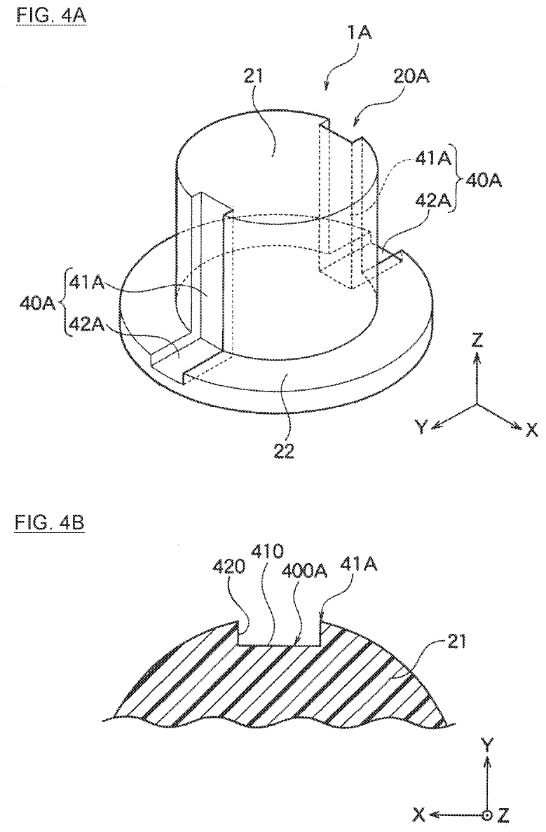

A coil device 1C of a fourth embodiment shown in FIG. 6A is identical to the coil device 1A of the second embodiment except for the following. In FIG. 6A, members other than a core 20C are omitted. In FIG. 6A, members common to the coil device 1A of the second embodiment are given the same reference numerals as in the second embodiment, and their detailed description is omitted.

As shown in FIG. 6A, the coil device 1C includes the core 20C. The core 20C is different from the core 20A of the second embodiment in that the core 20C includes recesses 40C. As shown in FIG. 6B, side wall portions 420 of an inner wall 400C of a first recess 41C (the same applies to a second recess 42C) include angled portions (angled surfaces). Thus, as shown in FIG. 6A, each recess 40C has a width W that widens towards the bottom of the recess 40C.

The present embodiment can also achieve the same effects as in the second embodiment. Additionally, in the present embodiment, because the inner wall 400C of each recess 40C includes the angled portions having the shape shown in FIG. 6B, the exterior material is joined to (engages with) the columnar portion 21 at high bonding strength when the exterior material that has flowed into the recess 40C hardens. Thus, adhesion between the exterior body 30 (FIG. 1A) and the columnar portion 21 improve, which can increase the peel strength of the exterior body 30 from the columnar portion 21.

In some embodiments, in terms of ensuring moldability, it may be that only the inner wall 400C of the first recess 41C has the angled portions shown in FIG. 6A and that the inner wall 400C of the second recess 42C has a shape identical to any of the inner walls 400, 400A, and 400B of the second recess 42 of the first to third embodiments.

### Fifth Embodiment

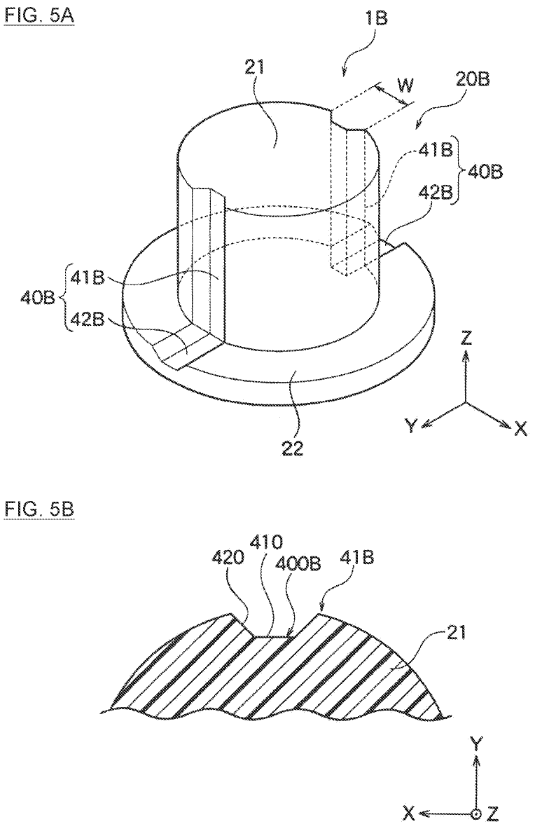

A coil device 1D of a fifth embodiment shown in FIG. 7A is identical to the coil device 1C of the fourth embodiment except for the following. In FIG. 7A, members other than a core 20D are omitted. In FIG. 7A, members common to the coil device 1C of the fourth embodiment are given the same reference numerals as in the fourth embodiment, and their detailed description is omitted.

As shown in FIG. 7A, the coil device 1D includes the core 20D. The core 20D is different from the core 20C of the fourth embodiment in that the core 20D includes recesses 40D. As shown in FIG. 7B, an inner wall 400D of a first recess 41D (the same applies to a second recess 42D) is curved. When viewed from the Z-axis direction, the first recess 41D is cut out in a substantially C shape and has a substantially oval cross-sectional shape.

The present embodiment can also achieve the same effects as in the fourth embodiment. Additionally, in the present embodiment, because the inner wall 400D is curved, fluidity of the exterior material that flows inside the recesses 40D is readily ensured, and the exterior material (particularly the magnetic particles) can be efficiently transferred through the recesses 40D into the spaces G1 and G2 (FIG. 3A).

In some embodiments, in terms of ensuring moldability, it may be that only the inner wall 400D of the first recess 41D has the curved shape shown in FIG. 7A and that the inner wall 400D of the second recess 42D has a shape identical to any of the inner walls 400, 400A, and 400B of the second recess 42 of the first to third embodiments.

### Sixth Embodiment

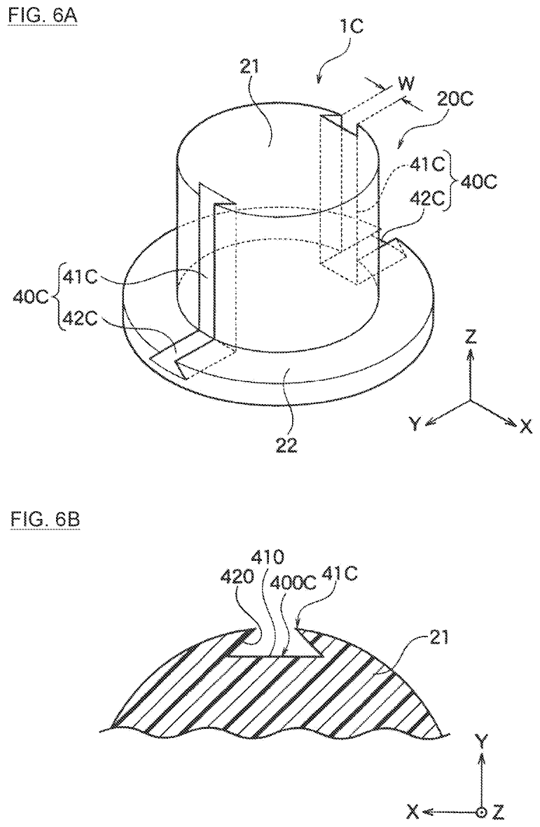

A coil device 1E of a sixth embodiment shown in FIG. 8 is identical to the coil device 1A of the second embodiment except for the following. In FIG. 8, members other than a core 20E are omitted. In FIG. 8, members common to the coil device 1A of the second embodiment are given the same reference numerals as in the second embodiment, and their detailed description is omitted.

As shown in FIG. 8, the coil device 1E includes the core 20E. The core 20E is different from the core 20A of the second embodiment in that the core 20E includes recesses 40E. The recesses 40E include, in addition to first recesses 41A and second recesses 42A, third recesses 43. Each of the third recesses 43 is formed in an arc shape on the outer peripheral surface of the columnar portion 21 and extends along the circumferential direction of the columnar portion 21 for substantially half the circumference of the columnar portion 21.

Each third recess 43 extends along the circumferential direction of the columnar portion 21. This extending direction is substantially the same as the winding direction of the coil 10 (FIG. 1A) (the extending direction of the wire 11). Thus, a width of the third recess 43 in a direction (the Z-axis direction) orthogonal to the extending direction of the third recess 43 is preferably smaller than the diameter of the wire 11 so that the wire 11 does not fit into the third recess 43. In some embodiments, the third recess 43 may extend along a direction inclined to the circumferential direction of the columnar portion 21.

At any location between the first end 21a and the second end 21b of the columnar portion 21, the third recesses 43 are connected to the first recesses 41A. Although the third recesses 43 are connected to the first recesses 41A at a central part of the columnar portion 21 in the Z-axis direction in the present embodiment, the third recesses 43 may be connected to the first recesses 41A at a location above or below the central part.

Although the third recess 43 of one recess 40E connects the first recess 41A of one recess 40E and the first recess 41A of the other recess 40E, the third recess 43 may be connected to only the first recess 41A of the one recess 40E. Although the third recess 43 of the other recess 40E connects the first recess 41A of the one recess 40E and the first recess 41A of the other recess 40E, the third recess 43 may be connected to only the first recess 41A of the other recess 40E. That is, each recess 40E may include one first recess 41A, one second recess 42A, and one third recess 43.

Although the number of the third recesses 43 formed on the outer peripheral surface 210 of the columnar portion 21 is two, three or more third recess 43 may be formed. The third recesses and the first recesses 41A may be formed on the outer peripheral surface 210 so as to intersect in a lattice pattern.

The present embodiment can also achieve the same effects as in the second embodiment. Additionally, in the present embodiment, part of the exterior material that has flowed into the first recesses 41A flows into the third recesses 43, and part of the exterior material that has flowed into the third recesses 43 outflows outside the third recesses 43 into the space G1 (FIG. 3A). Consequently, the space G1 can be filled with the exterior material widely along the circumferential direction of the columnar portion 21. This can effectively improve the magnetic properties and yield of the coil device 1E.

### Seventh Embodiment

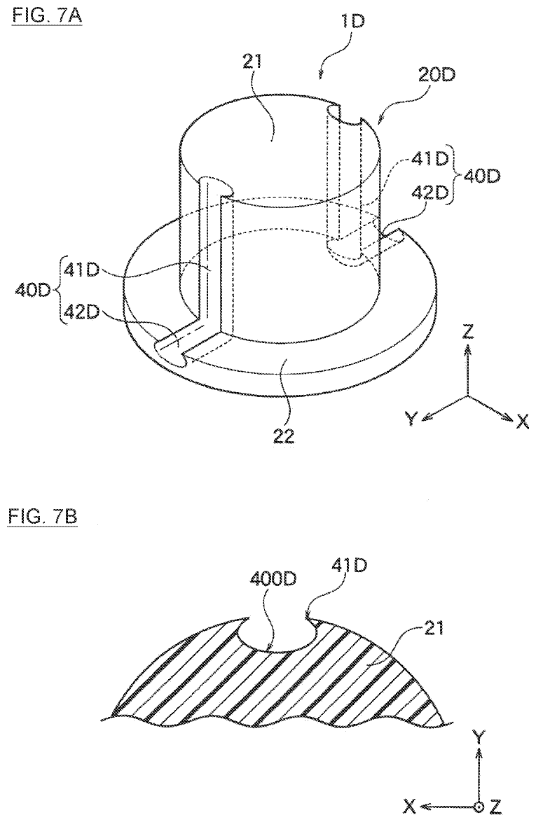

A coil device 1F of a seventh embodiment shown in FIG. 9 is identical to the coil device 1A of the second embodiment except for the following. In FIG. 9, members other than a core 20F are omitted. In FIG. 9, members common to the coil device 1A of the second embodiment are given the same reference numerals as in the second embodiment, and their detailed description is omitted.

As shown in FIG. 9, the coil device 1F includes the core 20F. The core 20F is different from the core 20A of the second embodiment in that the core 20F includes recesses 40F. Each of first recesses 41F extends in a direction inclined to the axial direction of the columnar portion 21 or the winding axis direction of the coil 10 (FIG. 1A). More specifically, the first recess 41F is spirally formed on the outer peripheral surface of the columnar portion 21 from the second end 21b to the first end 21a of the columnar portion 21.

One first recess 41F (the one interconnected with the second recess 42A in the positive direction of the Y-axis) spirals down counterclockwise about halfway around the outer peripheral surface of the columnar portion 21 from its end in the negative direction of the Y-axis to its end in the positive direction of the Y-axis. The location of the upper end of this first recess 41F corresponds to the location of the second recess 42A in the negative direction of the Y-axis, and the upper end is located directly above this second recess 42A.

The other first recess 41F (the one interconnected with the second recess 42A in the negative direction of the Y-axis) spirals down counterclockwise about halfway around the outer peripheral surface of the columnar portion 21 from its end in the positive direction of the Y-axis to its end in the negative direction of the Y-axis. The location of the upper end of this first recess 41F corresponds to the location of the second recess 42A in the positive direction of the Y-axis, and the upper end is located directly above this second recess 42A.

The present embodiment can also achieve the same effects as in the second embodiment. Additionally, in the present embodiment, each first recess 41F includes a component extending in the axial direction of the columnar portion 21 from the second end 21b to the first end 21a of the columnar portion 21 and a component extending in the circumferential direction of the columnar portion 21. Consequently, the space G1 (FIG. 3A) can be filled with the exterior material widely along the circumferential direction of the columnar portion 21. This can effectively improve the magnetic properties and yield of the coil device 1F.

### Eighth Embodiment

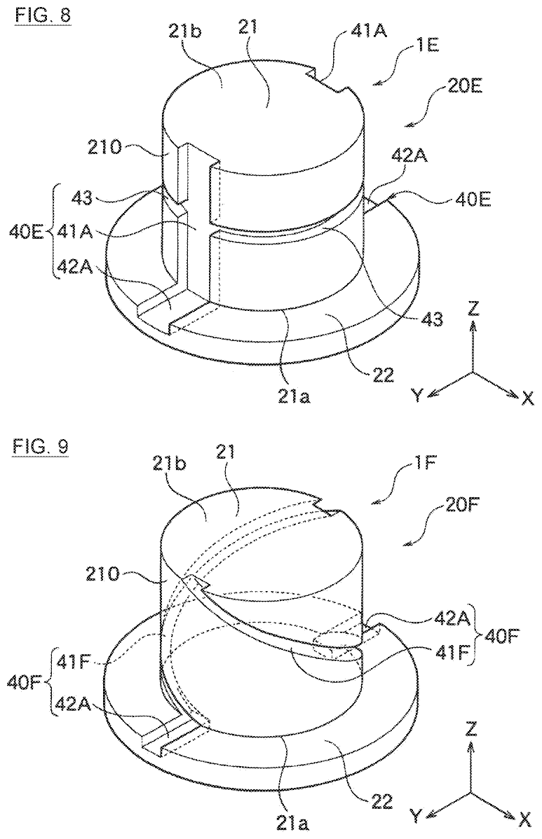

A coil device 1G of an eighth embodiment shown in FIG. 10 is identical to the coil device 1A of the second embodiment except for the following. In FIG. 10, members other than a core 20G are omitted. In FIG. 10, members common to the coil device 1A of the second embodiment are given the same reference numerals as in the second embodiment, and their detailed description is omitted.

As shown in FIG. 10, the coil device 1G includes the core 20G. The core 20G is different from the core 20A of the second embodiment in that the core 20G includes recesses 40G. A first recess 41G of each recess 40G has a tapered shape (an inverted triangular shape) as a whole. A width W1 of the first recess 41G at the first end 21a of the columnar portion 21 is smaller than a width W2 of the first recess 41G at the second end 21b of the columnar portion 21. That is, towards the first end 21a of the columnar portion, the first recess 41G narrows in a direction orthogonal to the extending direction of the first recess 41G. The second recess 42A is as wide as the width W1 of the first recess 41G at the first end 21a of the columnar portion 21.

In some embodiments, the first recess 41G may widen in the direction orthogonal to the extending direction of the first recess 41G towards the first end 21a of the columnar portion. Also, the second recess 42A may be formed so as to be narrower (or wider) towards the outer side of the flange 22 in its radial direction.

The present embodiment can also achieve the same effects as in the second embodiment. Additionally, in the present embodiment, because the width W2 of the first recess 41G widens towards the second end 21b of the columnar portion 21 (corresponding to the opening side of the cavity), part of the exterior material readily enters the first recess 41G when the exterior material is poured into the cavity. This allows a sufficient amount of the exterior material to flow into the first recess 41G and the second recess 42A. Thus, the spaces G1 and G2 (FIG. 3A) can be easily filled with the exterior material.

In terms of ensuring easiness of the exterior material entering the first recess 41G, a ratio (W1/W2) of the width W1 of the first recess 41G to the width W2 thereof may satisfy 1/8≤W1/W2<1 or 1/8≤W1/W2<1/2.

Moreover, because the first recess 41G having the above-mentioned shape functions as a draft angle when the core 20G is removed from the mold, molding of the core 20G is easy.

### Ninth Embodiment

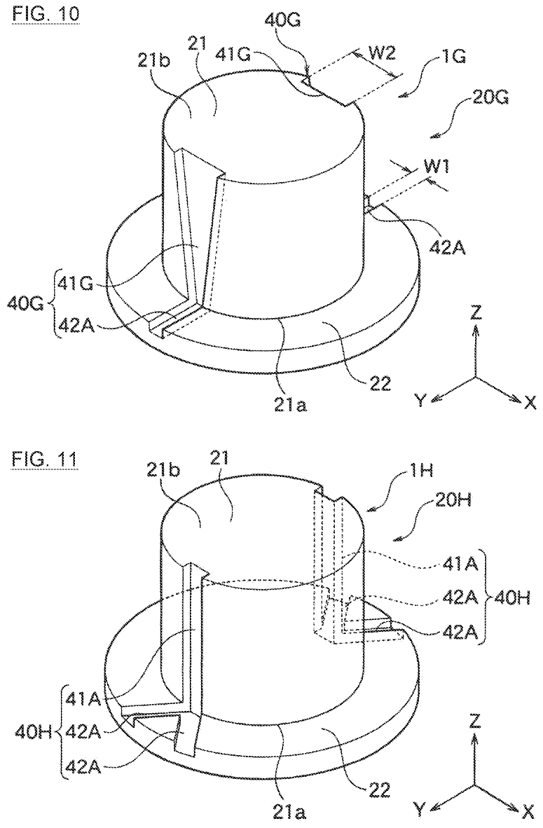

A coil device 1H of a ninth embodiment shown in FIG. 11 is identical to the coil device 1A of the second embodiment except for the following. In FIG. 11, members other than a core 20H are omitted. In FIG. 11, members common to the coil device 1A of the second embodiment are given the same reference numerals as in the second embodiment, and their detailed description is omitted.

As shown in FIG. 11, the coil device 1H includes the core 20H. The core 20H is different from the core 20A of the second embodiment in that the core 20H includes recesses 40H. Each recess 40H includes two second recesses 42A. Each second recess 42A extends in a direction inclined to the radial direction of the flange 22 so that the two second recesses 42A diverge outwardly in the radial direction of the flange 22. Each second recess 42A is interconnected with a lower end of the corresponding first recess 41A at the first end 21a of the columnar portion 21. That is, the first recess 41A diverges into the two second recesses 42A at the first end 21a of the columnar portion 21.

The present embodiment can also achieve the same effects as in the second embodiment. Additionally, in the present embodiment, the exterior material that has flowed into each first recess 41A flows into the second recesses 42A. Part of the exterior material that has flowed into one second recess 42A flows into the space G2 (FIG. 3A) near the one second recess 42A, and part of the exterior material that has flowed into the other second recess 42A flows into the space G2 (FIG. 3A) near the other second recess 42A. Consequently, the space G2 can be filled with the exterior material widely along the circumferential direction of the flange 22. This can effectively improve the magnetic properties and yield of the coil device 1H.

The present disclosure is not limited to the above-mentioned embodiments and may variously be modified within the scope of the present disclosure.

In the description of the above-mentioned embodiments, examples of applying the present disclosure to an inductor are illustrated. However, the present disclosure may be applied to other coil devices, such as transformers.

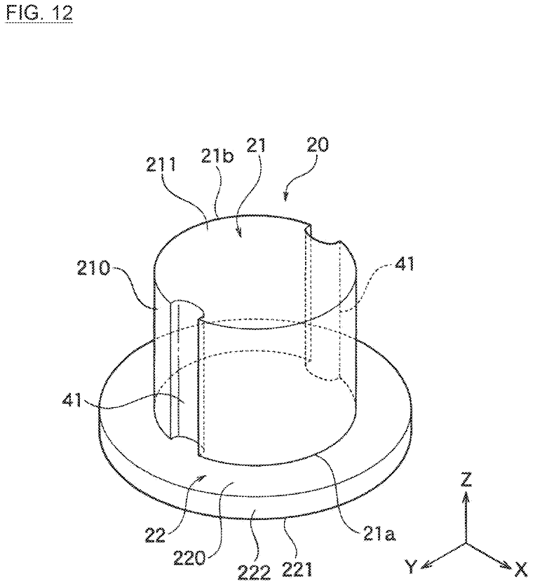

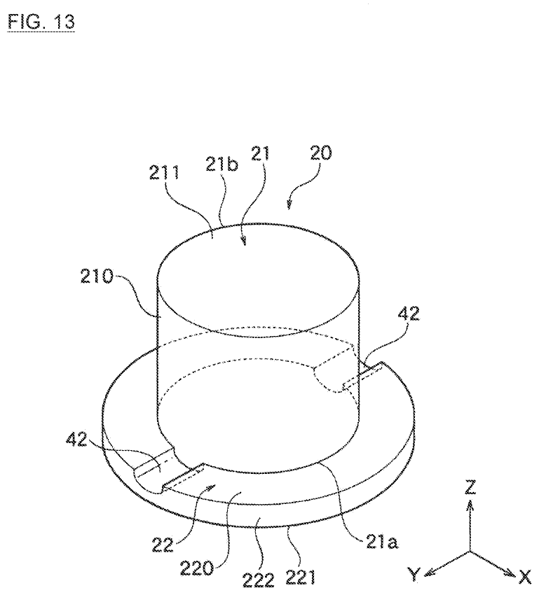

In the first embodiment, either the first recesses 41 or the second recesses 42 shown in FIG. 2A may be omitted as shown in FIGS. 12 and 13. The same applies to the second to ninth embodiments.

Although the core 20 includes the two recesses 40 in the first embodiment, the number of the recesses 40 may be one or may be three or more. The same applies to the second to ninth embodiments.

Although one recess 40 and the other recess 40 have the same shape in the first embodiment, the two recesses 40 may have different shapes. For example, the first recess 41 and the second recess 42 of one recess 40 may have a width W larger than that of the first recess 41 and the second recess 42 of the other recess 40. The same applies to the second to ninth embodiments.

Although the outer end of each second recess 42 in the radial direction is an open end in the first embodiment, the outer end may be a closed end. That is, the outer end of the second recess 42 in the radial direction may be closed with a wall. The same applies to the second to ninth embodiments.

In the sixth embodiment (FIG. 8), the inner wall of each recess 40E (the first recess 41A, the second recess 42A, and/or the third recess 43) may be changed to a shape of any inner wall shown in FIG. 2B, FIG. 5B, FIG. 6B, or FIG. 7B. The same applies to the seventh embodiment (FIG. 9) and the subsequent embodiments.

Although the third recesses 43 extend along the circumferential direction of the columnar portion 21 in the sixth embodiment, the third recesses 43 may extend in a direction inclined to the circumferential direction of the columnar portion 21. For example, the third recesses 43 may have a spiral shape like the first recesses 41F of the seventh embodiment.

Techniques illustrated in the seventh embodiment (FIG. 9), the eighth embodiment (FIG. 10), and/or the ninth embodiment (FIG. 11) may be applied to the sixth embodiment (FIG. 8). Techniques illustrated in the eighth embodiment and/or the ninth embodiment may be applied to the seventh embodiment. Techniques illustrated in the ninth embodiment may be applied to the eighth embodiment.

### EXAMPLES

Hereinafter, the present disclosure will be explained based on further detailed examples. However, the present disclosure is not limited to the examples.

### Example 1

A coil device 1 (sample) shown in FIG. 1A was manufactured using the manufacturing method explained in the description of the first embodiment. In manufacture of the sample, a core having a constant width W of a first recess 41 along the Z-axis direction as shown in FIG. 2A was used as a core 20. The core 20 had a relative permeability of 25. A columnar portion 21 had a diameter of 1.8 mm and a length of 1.1 mm in its axial direction. A flange 22 had a thickness of 0.4 mm. A round wire having a diameter of 0.2 mm and 8.5 turns of windings was used as a wire 11 forming a coil 10 (FIG. 1A). An exterior body 30 (FIG. 1A) was molded by transfer molding. The exterior body 30 had a relative permeability of 25. The exterior body 30 had a dimension of 3.5 mm in the X-axis direction, a dimension of 3.5 mm in the Y-axis direction, and a dimension of 2.0 mm in the Z-axis direction.

Ten such samples were prepared, and the inductance of each sample was measured to calculate the average inductance of these samples. Table 1 shows the results.

A defect rate of the samples was evaluated. The defect rate of the samples was evaluated based on whether the exterior body 30 peeled from the columnar portion 21 or whether the exterior body 30 peeled from the flange 22. Peeling was evaluated as “peeling confirmed” when, in observation of a cross section of a sample with an optical microscope, presence of a gap was able to be confirmed at an interface between the columnar portion 21 and the exterior body 30 or an interface between the flange 22 and the exterior body 30. Table 1 shows the results. Table 1 shows the percentage of the ten samples evaluated as “peeling confirmed”.

### Example 2

Samples similar to those of Example 1 were manufactured for evaluation as in Example 1 except that a core (corresponding to a core 20G) having a smaller width W of the first recess 41 towards the lower end of the columnar portion 21 as shown in FIG. 10 was used as the core 20. Table 1 shows the results.

### Example 3

Samples similar to those of Example 1 were manufactured for evaluation as in Example 1 except that a core having a larger width W of the first recess 41 towards the lower end of the columnar portion 21 (i.e., a core having an upside down tapered shape of a first recess 41G shown in FIG. 10) was used as the core 20. Table 1 shows the results.

### Example 4

Samples similar to those of Example 1 were manufactured for evaluation as in Example 1 except that a core having only the first recesses 41 and not having the second recesses 42 was used as the core 20. Table 1 shows the results.

### Example 5

Samples similar to those of Example 1 were manufactured for evaluation as in Example 1 except that a core having only the second recesses 42 and not having the first recesses 41 was used as the core 20. Table 1 shows the results.

### Comparative Example

Samples similar to those of Example 1 were manufactured for evaluation as in Example 1 except that a core having neither the first recesses 41 nor the second recesses 42 was used as the core 20. Table 1 shows the results.

TABLE 1

| | | | | | | | Comparative |
|---|---|---|---|---|---|---|---|
| | | Example 1 | Example 2 | Example 3 | Example 4 | Example 5 | Example |
| Availability of first recesses | | Available | Available | Available | Available | Unavailable | Unavailable |
| Width of first recesses | | Constant | Tapered | Tapered | Constant | — | — |
| | | | (narrower | (wider | | | |
| | | | towards | towards | | | |
| | | | lower end) | lower end) | | | |
| Depth of first recess [mm] | | 0.2 | 0.2 | 0.2 | 0.2 | — | — |
| Number of first recesses | | 2 | 2 | 2 | 2 | — | — |
| Availability of second recesses | | Available | Available | Available | Unavailable | Available | Unavailable |
| Width of second recesses | | Constant | Constant | Constant | — | Constant | — |
| Inductance [uH] | | 2.53 | 2.58 | 2.50 | 2.46 | 2.40 | 2.29 |
| Defect | Peeling of exterior body | 0 | 0 | 0 | 0 | 20 | 80 |
| rate | from columnar portion [%] | | | | | | |
| | Peeling of exterior body | 0 | 0 | 0 | 20 | 0 | 70 |
| | from flange [%] | | | | | | |

As shown in Table 1, the samples had better inductance in Examples 1 to 5 than in Comparative Example. These results revealed that forming the first recesses 41 and/or the second recesses 42 on a surface of the core 20 could improve magnetic properties of the coil device 1. In particular, it was revealed that the samples had extremely good inductance in Examples 1 and 2 and that the shapes of the first recesses 41 of Examples 1 and 2 significantly contributed to improvement of the magnetic properties of the coil device 1.

As shown in Table 1, in Examples 1 to 3, no peeling was confirmed at the interface between the columnar portion 21 and the exterior body 30 or the interface between the flange 22 and the exterior body 30. In Example 4 in which the recesses were formed on the columnar portion 21, no peeling was confirmed at the interface between the columnar portion 21 and the exterior body 30 whereas slight peeling was confirmed at the interface between the flange 22 and the exterior body 30. In Example 5 in which the recesses were formed on the flange 22, no peeling was confirmed at the interface between the flange 22 and the exterior body 30 whereas slight peeling was confirmed at the interface between the columnar portion 21 and the exterior body 30. In contrast, in Comparative Example, it was confirmed that peeling occurred at a relatively high percentage at both the interface between the columnar portion 21 and the exterior body 30 and the interface between the flange 22 and the exterior body 30.

### REFERENCE NUMERALS

1, 1A to 1H . . . coil device
10 . . . coil
10a . . . bottom surface
10b . . . inner peripheral surface
11 . . . wire
11a, 11b . . . lead-out portion
20 . . . core
21 . . . columnar portion
21a . . . first end
21b . . . second end
210 . . . outer peripheral surface
211 . . . upper surface
22 . . . flange
220 . . . upper surface
221 . . . lower surface
222 . . . side surface
30 . . . exterior body
40, 40A to 40H . . . recess
41 to 43, 41A, 42A, 41B, 42B, 41C, 42C, 41D, 42D, 41F, 41G . . . first recess to third recess
400, 400A to 400D . . . inner wall
51 . . . first electrode
52 . . . second electrode
G1, G2 . . . space

What is claimed is:

1. A coil device comprising:
a coil;
a T-shaped core including a columnar portion around which the coil is disposed and a flange formed at a first end of the columnar portion in an axial direction thereof; and
an exterior body covering the coil and the columnar portion and made of an exterior material including magnetic particles and a resin; wherein
the core is provided with a recess including at least one of a first recess or a second recess;
the first recess extends between the first end and a second end of the columnar portion in the axial direction; and
the second recess extends from an inner side towards an outer side of the flange.

2. The coil device according to claim 1, wherein
the recess comprises the first recess and the second recess; and
the second recess is interconnected with the first recess at the first end of the columnar portion.

3. The coil device according to claim 1, wherein
an inner wall of the recess has an angled portion; and
a width of the recess in a direction orthogonal to an extending direction of the recess narrows towards a bottom of the recess.

4. The coil device according to claim 1, wherein
an inner wall of the recess has an angled portion; and
a width of the recess in a direction orthogonal to an extending direction of the recess widens towards a bottom of the recess.

5. The coil device according to claim 1, wherein a width of the first recess in a direction orthogonal to an extending direction of the first recess narrows towards the first end of the columnar portion.

6. The coil device according to claim 1, wherein
the recess comprises a third recess extending along a circumferential direction of the columnar portion or a direction inclined to the circumferential direction; and
the third recess is connected to the first recess at a location between the first end and the second end of the columnar portion.

7. The coil device according to claim 1, wherein the first recess extends in a direction inclined to the axial direction of the columnar portion.

8. The coil device according to claim 1, wherein the coil comprises an air core coil.

9. The coil device according to claim 1, wherein the columnar portion has a thermal expansion coefficient smaller than that of the exterior body.

10. A method of manufacturing a coil device, comprising:
preparing a T-shaped core having a recess extending from a columnar portion of the core to a flange formed at a first end of the columnar portion in an axial direction thereof;
disposing a coil around the columnar portion;
disposing the core with the coil in a cavity so that the flange abuts a bottom of the cavity;
filling the cavity with an exterior material including magnetic particles and a resin so that part of the exterior material flows into the recess; and
compressing the exterior material.
